(19) United States
(12) Patent Application Publication
(10) Pub. No.: US 2023/0339331 A1
(43) Pub. Date: Oct. 26, 2023

(54) FAILURE DETERMINATION DEVICE, DRIVE CONTROL DEVICE, AND FAILURE DETERMINATION METHOD

(71) Applicant: MITSUBISHI ELECTRIC CORPORATION, Chiyoda-ku, Tokyo (JP)

(72) Inventor: Etsuji MATSUYAMA, Tokyo (JP)

(73) Assignee: Mitsubishi Electric Corporation, Chiyoda-ku, Tokyo (JP)

(21) Appl. No.: 18/044,822

(22) PCT Filed: Oct. 30, 2020
(86) PCT No.: PCT/JP2020/040760

§ 371 Date: Mar. 10, 2023

(51) Int. Cl. G01P 3/481; B60L 3/00

(52) U.S. Cl. CPC B60L 3/0061; B60L 3/0076; G01P 3/481

(57) ABSTRACT

A failure determination device determines whether any failure occurs in a rotating body including a shaft rotatable by received power and a support mechanism supporting the shaft rotatably. In detail, the failure determination device includes a rate generator, a frequency calculator, and a determiner. The rate generator outputs a sensor signal of which a frequency varies depending on a rotational speed of the shaft. The frequency calculator calculates a frequency of the sensor signal. The determiner determines whether any failure occurs in the rotating body from the frequency calculated by the frequency calculator.

### TECHNICAL FIELD

The present disclosure relates to a failure determination device, a drive control apparatus including the failure determination device, and a failure determining method.

### BACKGROUND ART

In a typical railway vehicle, electric power acquired by a current collector via an overhead wire is converted into electric power for driving a motor, and the converted electric power is fed to the motor, for example. The motor receives the electric power and thus rotates, so that an axle connected to the shaft of the motor via a joint and gears rotates, thereby providing a thrust of the railway vehicle. In order to improve the maintainability of the railway vehicle, the railway vehicle or a direction center is provided with a failure determination device to determine the existence of a failure in a power transmission mechanism for transmitting power from the motor to the axle. A typical example of this type of failure determination device is disclosed in Patent Literature 1.

The breakage detection device disclosed in Patent Literature 1 includes two rate generators to measure a rotational speed of the armature shaft of a motor and a rotational speed of an axle. In detail, each of the rate generators includes a gear attached to the armature shaft or the axle, a magnetic pole opposed to the gear in a radial direction, and a coil wound around the magnetic pole. By causing the coil to detect a change in the magnetic flux generated through rotation of the gear, the rate generator measures a rotational speed of the armature shaft or the axle. In an exemplary case where a bearing for supporting the axle rotatably is damaged and thus causes the axle to be deviated from the normal position, the distance between the magnetic pole and the gear attached to the axle differs from the normal distance. This difference varies the manner of change in the magnetic flux from the normal manner. The rotational speed of the axle measured by the rate generator is therefore different from the normal rotational speed of the axle, which is normally measured by the rate generator, thereby increasing the difference between the rotational speed of the armature shaft and the rotational speed of the axle. The breakage detection device disclosed in Patent Literature 1 is thus configured to deem a support structure to be broken when the difference between the rotational speed of the armature shaft and the rotational speed of the axle is equal to or higher than a threshold.

### CITATION LIST

### Patent Literature

Patent Literature 1: Japanese Patent No. 5947144

### SUMMARY OF INVENTION

### Technical Problem

The breakage detection device disclosed in Patent Literature 1 needs two rate generators to measure the rotational speeds of the armature shaft and the axle. In addition, the breakage detection device also requires a voltage detection circuit to detect voltages of sensor signals output from the respective rate generators so as to calculate the difference between the values measured by the rate generators. The breakage detection device disclosed in Patent Literature 1 thus inevitably has a complicated structure. This problem can occur in the cases where rate generators are used to determine the existence of a failure in a rotating body including a shaft rotatable by received power and a support mechanism supporting the shaft rotatably.

An objective of the present disclosure, which has been accomplished in view of the above situations, is to provide a failure determination device capable of determining the existence of a failure in the rotating body with a simple configuration, a drive control apparatus, and a failure determining method.

### Solution to Problem

In order to achieve the above objective, a failure determination device according to an aspect of the present disclosure is configured to determine whether any failure occurs in a rotating body including a shaft rotatable by received power and a support mechanism for supporting the shaft rotatably. The failure determination device includes a rate generator, a frequency calculator, and a determiner. The rate generator outputs a sensor signal of which a frequency varies depending on a rotational speed of the shaft. The frequency calculator calculates a frequency of the sensor signal. The determiner determines whether any failure occurs in the rotating body from the frequency calculated by the frequency calculator.

### Advantageous Effects of Invention

The failure determination device according to an aspect of the present disclosure determines the existence of a failure in the rotating body from the frequency of the sensor signal, and is therefore not required to measure a rotational speed of another member that receives a torque from the shaft, and does not need a voltage detection circuit for measuring a voltage value of the sensor signal. This failure determination device therefore has a simple structure.

### BRIEF DESCRIPTION OF DRAWINGS

FIG. 1 is a block diagram illustrating a configuration of a drive control apparatus according to Embodiment 1;

FIG. 2 is a block diagram illustrating a configuration of a failure determination device according to Embodiment 1;

FIG. 3 illustrates an exemplary output from a rate generator according to Embodiment 1;

FIG. 4 illustrates an exemplary output from a waveform generator according to Embodiment 1;

FIG. 5 illustrates an exemplary relationship between the frequency and the amplitude of a sensor signal according to Embodiment 1;

FIG. 6 is a block diagram illustrating a hardware configuration of the failure determination device according to Embodiment 1;

FIG. 7 is a flowchart illustrating an exemplary failure determining process executed by the failure determination device according to Embodiment 1;

FIG. 8 is a block diagram illustrating a configuration of a failure determination device according to Embodiment 2;

FIG. 9 is a flowchart illustrating an exemplary failure determining process executed in the failure determination device according to Embodiment 2; and

FIG. 10 is a flowchart illustrating another exemplary failure determining process executed in a failure determination device according to the embodiments.

### DESCRIPTION OF EMBODIMENTS

A failure determination device, a drive control apparatus, and a failure determining method according to embodiments of the present disclosure are described in detail below with reference to the accompanying drawings. In the drawings, the components identical or corresponding to each other are provided with the same reference symbol.

### Embodiment 1

The following description is directed to a failure determination device 1 to determine whether any failure occurs in a rotating body including a shaft rotatable by received power and a support mechanism supporting the shaft rotatably, and a drive control apparatus 10 including the failure determination device 1 to control, in accordance with a result of determination from the failure determination device 1, a driving apparatus 50 for providing power to the rotating body. In Embodiment 1, the failure determination device 1 determines whether any failure occurs in a bogie of a railway vehicle. The rotating body, on which the failure determination device 1 determines the existence of a failure, is included in the bogie. An axle of the bogie corresponds to the shaft, and a bearing for supporting the axle rotatably corresponds to the support mechanism. The drive control apparatus 10 controls the driving apparatus 50 for generating a thrust of the railway vehicle.

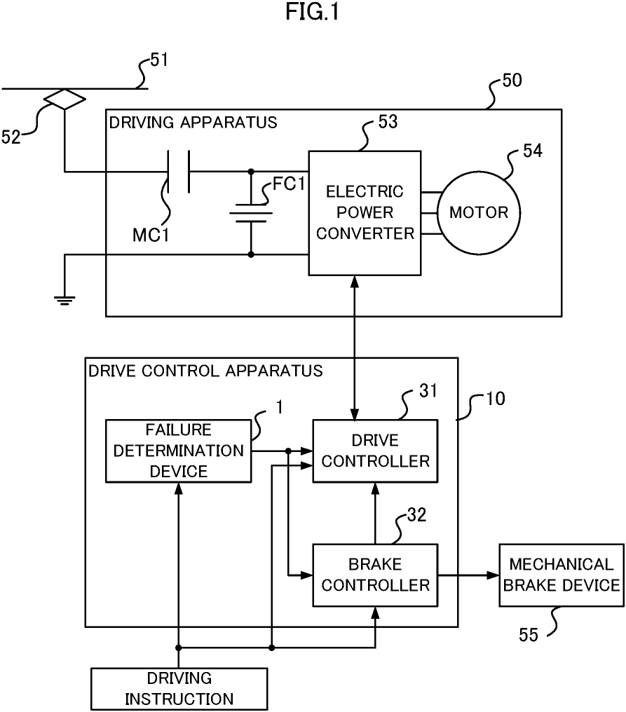

As illustrated in FIG. 1, the driving apparatus 50 for generating a thrust of the railway vehicle and the drive control apparatus 10 for controlling the driving apparatus 50 are installed in the railway vehicle.

The driving apparatus 50 includes a contactor MC1 to electrically connect an electric power converter 53 to a current collector 52, which is configured to acquire DC power via an overhead wire 51, or electrically disconnect the electric power converter 53 from the current collector 52, a filter capacitor FC1 connected between the primary terminals of the electric power converter 53, the electric power converter 53 to convert the DC power fed via the filter capacitor FC1 into three-phase AC power to be fed to a motor 54 and feed the three-phase AC power to the motor 54, and the motor 54 driven by the electric power converter 53 to provide power to the axle.

For example, the electric power converter 53 is an inverter that can vary the effective voltage and the frequency of AC power to be output. The motor 54 is a three-phase induction motor. The electric power converter 53 feeds three-phase AC power to the motor 54 and thereby drives the motor 54. The driven motor 54 provides power to the axle via a joint and gears.

In order to decelerate the railway vehicle by means of electric brake, the electric power converter 53 is preferably an inverter capable of bidirectional electric power conversion. In this case, the electric power converter 53 during braking of the railway vehicle converts three-phase AC power generated by the motor 54, which serves as an electric generator, into DC power to be fed via the overhead wire 51 to other railway vehicles running in the vicinity. The three-phase AC power generated by the motor 54 is fed to and consumed in other railway vehicles, resulting in generation of electric braking force for decelerating the railway vehicle.

The drive control apparatus 10 includes the failure determination device 1 to determine whether any failure occurs in a bogie, a drive controller 31 to control the on and off states of multiple switching elements of the electric power converter 53 included in the driving apparatus 50 in accordance with a driving instruction acquired from a cab, which is not illustrated, and a brake controller 32 to cause at least either of electric braking force and mechanical braking force to be generated in accordance with the driving instruction. Examples of the failure in the bogie include damage and abrasion in axles of the bogie and damage and abrasion in bearings for supporting the axles rotatably.

The failure determination device 1 calculates a frequency of a sensor signal output from a rate generator 11, which is described below, and determines whether any failure occurs in the bogie from the calculated frequency. Since the determination of the existence of a failure in the bogie is conducted from the frequency of the sensor signal, the failure determination device 1 is not required to measure a rotational speed of another member rotatable together with rotation of the axle, for example, a rotational speed of the armature shaft of the motor 54, which is described below, and does not need a voltage detection circuit for measuring a voltage value of the sensor signal. The failure determination device 1 and the drive control apparatus 10 including the failure determination device 1 therefore have simple structures.

The individual components of the drive control apparatus 10 are described in detail below.

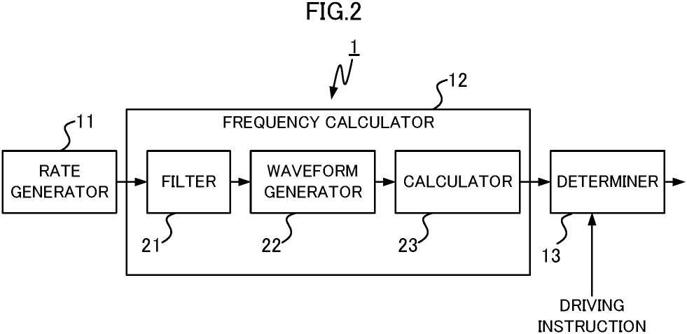

As illustrated in FIG. 2, the failure determination device 1 in the drive control apparatus 10 includes the rate generator 11 to output a sensor signal of which the frequency varies depending on the rotational speed of the axle, a frequency calculator 12 to calculate a frequency of the sensor signal, and a determiner 13 to determine whether any failure occurs in the bogie including the rotating body from the frequency calculated by the frequency calculator 12.

The individual components of the failure determination device 1 are described in detail below.

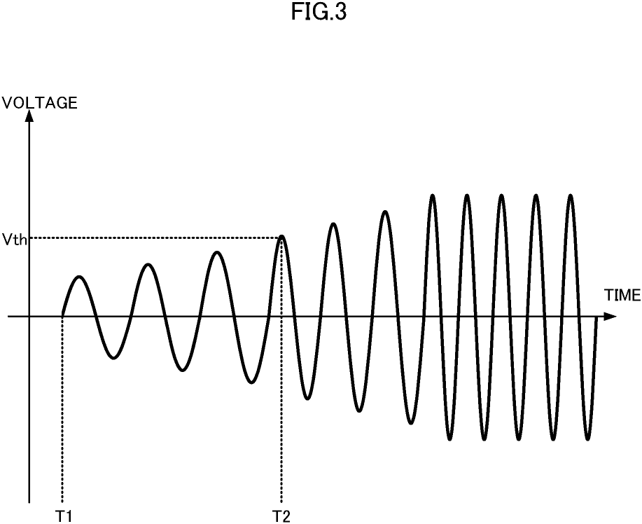

The rate generator 11 is a non-contact rate generator to detect rotation of the shaft of the rotating body. In detail, the rate generator 11 includes a gear attached to the axle, and a magnetic pole opposed to the gear in a radial direction, and a coil wound around the magnetic pole. When the gear rotates together with rotation of the axle, a magnetic path is formed in the magnetic pole, thereby generating a magnetic flux. The coil wound around the magnetic pole generates a voltage having a waveform depending on a change in the magnetic flux. The rate generator 11 thus outputs a sensor signal like that illustrated in FIG. 3. In FIG. 3, the horizontal axis indicates a time, and the vertical axis indicates a voltage value of the sensor signal.

In FIG. 3, a time T1 corresponds to the start of rotation of the axle. The frequency of the sensor signal varies depending on the rotational speed of the axle. In detail, the frequency of the sensor signal is proportional to the rotational speed of the axle. In other words, after the time T1, the frequency of the sensor signal increases in accordance with an increase in the rotational speed of the axle. The amplitude of the sensor signal is small immediately after the start of rotation of the axle, that is, immediately after the time T1, but increases in accordance with acceleration of the rotational speed. As a result, after the time T2, the amplitude of the sensor signal becomes large enough to allow the frequency calculator 12, which is described below, to calculate a frequency of the sensor signal. A sufficiently high rotational speed of the axle provides a constant amplitude of the sensor signal.

As illustrated in FIG. 2, the frequency calculator 12 includes a filter 21 to reduce noise in the sensor signal output from the rate generator 11, a waveform generator 22 to generate a pulse signal from the sensor signal output from the filter 21, and a calculator 23 to calculate a frequency of the sensor signal on the basis of the pulse signal.

A typical example of the filter 21 is a low pass filter (LPF). The filter 21 reduces noise superimposed on the sensor signal output from the rate generator 11. The filter 21 then provides the sensor signal after noise reduction to the waveform generator 22.

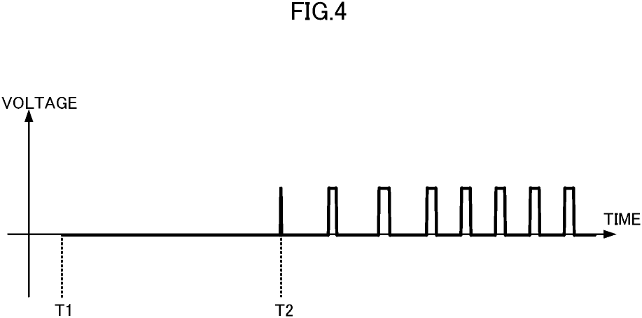

The waveform generator 22 generates a pulse signal like that illustrated in FIG. 4, on the basis of the sensor signal after noise reduction by the filter 21. In detail, the waveform generator 22 includes a comparator, for example, and compares the voltage value of the sensor signal after noise reduction at the filter 21 with a threshold voltage Vth. The waveform generator 22 outputs a signal at a high (H) level when the voltage value of the sensor signal is equal to or higher than the threshold voltage Vth, and outputs a signal at a low (L) level when the voltage value of the sensor signal is lower than the threshold voltage Vth. The threshold voltage Vth is preferably higher than the range of possible variation in the voltage of the sensor signal during stop of the axle. This configuration can avoid incorrect calculation of a frequency of the sensor signal on the basis of a variation in the voltage of the sensor signal.

The times T1 and T2 in FIG. 4 are respectively equal to the times T1 and T2 in FIG. 3. When the voltage value of the sensor signal illustrated in FIG. 3 arrives at the threshold voltage Vth at the time T2, the voltage of the pulse signal generated by the waveform generator 22 rises as illustrated in FIG. 4.

The calculator 23 counts the number of pulses per unit time on the basis of the pulse signal output from the waveform generator 22, and calculates a frequency of the sensor signal. The frequency of the pulse signal obtained by counting the number of pulses per unit time is equivalent to the frequency of the sensor signal generated by the rate generator 11. In detail, in response to detection of a rise of the pulse signal at the time T2, the calculator 23 starts calculation of a frequency of the sensor signal. For example, the calculator 23 includes a counter and a timer. The calculator 23 counts the number of pulses per unit time, calculates a frequency of the sensor signal in accordance with the counted number, and outputs the calculated frequency.

The determiner 13 illustrated in FIG. 2 determines whether any failure occurs in the bogie from the frequency of the sensor signal calculated by the frequency calculator 12. In detail, the determiner 13 preferably determines whether any failure occurs in the bogie from the frequency of the sensor signal, which is calculated by the frequency calculator 12 during acceleration of the rotational speed of the axle after the start of rotation of the axle. The determiner 13 acquires a driving instruction, and determines the existence of a failure in the bogie, from the frequency of the sensor signal calculated by the frequency calculator 12 after a change of the driving instruction from a braking instruction to a power running instruction. The change of the driving instruction from a braking instruction to a power running instruction is deemed as the start of rotation of the axle. The following description is directed to a method of determining whether any failure occurs in the bogie from the frequency of the sensor signal.

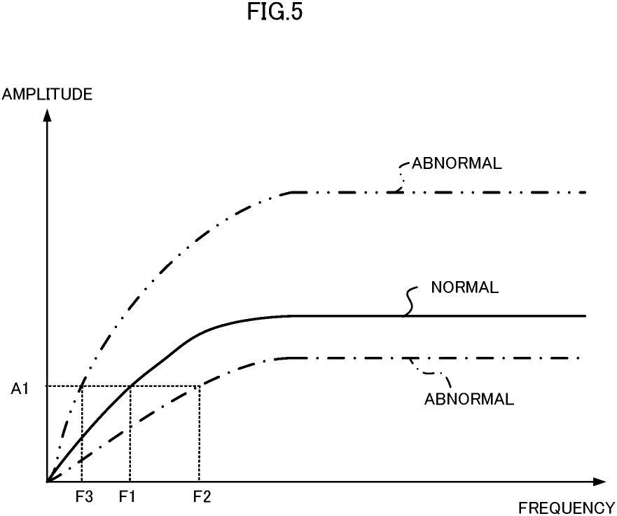

Since the frequency of the sensor signal varies depending on the rotational speed of the axle as described above, acceleration of the rotational speed of the axle increases the frequency of the sensor signal. The amplitude of the sensor signal is small immediately after the start of rotation of the axle, and increases in accordance with an acceleration of the rotational speed of the axle until the axle achieves a sufficiently high rotational speed. FIG. 5 illustrates a relationship between the frequency and the amplitude of the sensor signal. In FIG. 5, the horizontal axis indicates a frequency of the sensor signal, and the vertical axis indicates an amplitude of the sensor signal. The solid line represents a relationship between the frequency and the amplitude of the sensor signal in the case of no failure in the bogie in FIG. 5.

As represented as the time T2 in FIG. 3, the pulse signal generated by the waveform generator 22 rises in response to arrival of the voltage of the sensor signal at the threshold voltage Vth. The amplitude of the sensor signal at this time is defined as “amplitude A1”. As illustrated in FIG. 5, the frequency of the sensor signal calculated by the calculator 23 immediately after arrival of the amplitude of the sensor signal at the amplitude A1 in the case of no failure in the bogie is defined as “frequency F1”.

In the case of occurrence of a failure in the rotating body, such as damage in the bearing, when the axle is deviated from the normal position and thereby extends the distance between the gear and the magnetic pole of the rate generator 11, the sensor signal output from the rate generator 11 has a lower voltage than the normal voltage. Accordingly, the time required until arrival of the voltage of the sensor signal at the threshold voltage Vth, in other words, the time required until arrival of the amplitude of the sensor signal at the amplitude A1 is longer than the normal time. The relationship between the frequency and the amplitude of the sensor signal in this case is represented by the dashed and single-dotted line in FIG. 5. When the frequency of the sensor signal calculated by the calculator 23 immediately after arrival of the amplitude of the sensor signal at the amplitude A1 is defined as “frequency F2”, the frequency F2 is higher than the frequency F1.

In contrast, when the axle is deviated from the normal position and thereby reduces the distance between the gear and the magnetic pole of the rate generator 11, the sensor signal has a higher voltage than the normal voltage. Accordingly, the time required until arrival of the voltage of the sensor signal at the threshold voltage Vth, in other words, the time required until arrival of the amplitude of the sensor signal at the amplitude A1 is shorter than the normal time. The relationship between the frequency and the amplitude of the sensor signal in this case is represented by the dashed and double-dotted line in FIG. 5. When the frequency of the sensor signal calculated by the calculator 23 immediately after arrival of the amplitude of the sensor signal at the amplitude A1 is defined as “frequency F3”, the frequency F3 is lower than the frequency F1.

As described above, the occurrence of a failure in the rotating body changes the relationship between the frequency and the amplitude of the sensor signal output from the rate generator 11 for detecting rotation of the shaft of the rotating body. This change is used by the determiner 13 to determine whether any failure occurs in the bogie. The determiner 13 preferably determines the existence of a failure in the bogie from the frequency, which is calculated by the calculator 23 of the frequency calculator 12 immediately after the first rise of the pulse signal illustrated in FIG. 4 since the start of rotation of the axle. In other words, the determiner 13 preferably determines the existence of a failure in the axle from the frequency, which the frequency calculator 12 has calculated for the first time since the start of rotation of the axle.

For example, the determiner 13 determines whether the frequency calculated by the frequency calculator 12 is within a target frequency range. When the frequency calculated by the frequency calculator 12 is within the target frequency range, no failure is deemed to occur in the bogie. In contrast, when the frequency calculated by the frequency calculator 12 is not within the target frequency range, any failure is deemed to occur in the bogie. The target frequency range can be preliminarily defined through test runs or simulations. Specifically, the target frequency range is defined by the range encompassing possible frequencies of the sensor signal during acceleration of the rotational speed of the axle after the start of rotation of the axle in the case of no failure in the bogie. For example, the target frequency range is defined by the range encompassing possible frequencies of the sensor signal at the time of arrival of the amplitude of the sensor signal at the amplitude A1 in the case of no failure in the bogie, and upper and lower margins of 30%.

The failure determination device 1 preferably transmits a result of determination to the drive controller 31 and the brake controller 32, when determining that any failure occurs.

The drive controller 31 illustrated in FIG. 1 acquires the result of determination from the above-described failure determination device 1, and acquires a driving instruction from the cab, which is not illustrated. The drive controller 31 then controls the on and off states of the switching elements of the electric power converter 53 in accordance with the driving instruction. The driving instruction includes a power running instruction for instructing the vehicle to accelerate or a braking instruction for instructing the vehicle to decelerate. In detail, when the driving instruction includes a power running instruction, the drive controller 31 controls the electric power converter 53 in accordance with the target acceleration indicated by the power running instruction. The drive controller 31 preferably turns off the switching elements of the electric power converter 53 regardless of the driving instruction, when acquiring a result of determination indicating that any failure occurs from the failure determination device 1. This control causes the vehicle to stop acceleration and start coasting when the failure determination device 1 determines that any failure occurs in the bogie.

If an electric brake is available to decelerate the railway vehicle, the drive controller 31 controls the electric power converter 53 in accordance with a regenerative brake pattern signal acquired from the brake controller 32, which is described below. The electric power converter 53 thus converts three-phase AC power generated by the motor 54, which serves as an electric generator during braking of the railway vehicle, into DC power to be fed via the overhead wire 51 to other railway vehicles running in the vicinity. The three-phase AC power generated by the motor 54 is fed to and consumed in other railway vehicles, resulting in generation of electric braking force.

In contrast, when the driving instruction includes a braking instruction, the brake controller 32 controls a brake device for generating braking force of the railway vehicle, in accordance with the target deceleration indicated by the braking instruction. The brake device includes the electric power converter 53 to generate electric braking force and a mechanical brake device 55. Specifically, the brake controller 32 calculates total braking force, which is braking force to achieve the target deceleration, from the target deceleration indicated by the braking instruction and the weight of the vehicle acquired from a load compensator, which is not illustrated. The brake controller 32 then determines a target value of the electric braking force depending on the calculated total braking force, and provides the drive controller 31 with a regenerative brake pattern signal indicating the determined target value of the electric braking force. The brake controller 32 acquires actual braking force, which is actually generated electric braking force, from the drive controller 31. When the acquired actual braking force is smaller than the total braking force, the brake controller 32 controls the mechanical brake device 55 to generate mechanical braking force in order to achieve the total braking force.

The brake controller 32 preferably executes a control for generating at least either of electric braking force and mechanical braking force regardless of the driving instruction, when acquiring a result of determination indicating that any failure occurs from the failure determination device 1. For example, the brake controller 32 controls the mechanical brake device 55 to activate an emergency brake regardless of the driving instruction, when acquiring a result of determination indicating that any failure occurs from the failure determination device 1.

When the failure determination device 1 determines that any failure occurs in the bogie, the drive controller 31 included in the drive control apparatus 10 turns off the switching elements of the electric power converter 53 and thereby stops the driving apparatus 50, and the brake controller 32 generates braking force. These operations can allow the railway vehicle to stop safely.

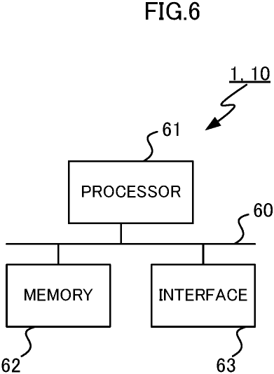

As illustrated in FIG. 6, the above-described failure determination device 1 and the drive control apparatus 10 have a hardware configuration including a processor 61, a memory 62, and an interface 63, to control the components. The processor 61, the memory 62, and the interface 63 are connected to each other via buses 60. The functions of the failure determination device 1 and the drive control apparatus 10 are achieved because the processor 61 executes programs stored in the memory 62. The interface 63 serves to connect each of the failure determination device 1 and the drive control apparatus 10 to an external device and establish communication. For example, the failure determination device 1 is connected to the drive control apparatus 10 via the interface 63. For another example, the drive control apparatus 10 transmits signals for controlling the switching elements of the electric power converter 53 to the switching elements via the interface 63. The interface 63 may include multiple types of interface modules as required.

Although the failure determination device 1 and the drive control apparatus 10 each include a single processor 61 and a single memory 62 in FIG. 6, the failure determination device 1 and the drive control apparatus 10 may each include multiple processors 61 and multiple memories 62. In this case, the processors 61 and the memories 62 cooperate with each other and thereby perform the individual functions.

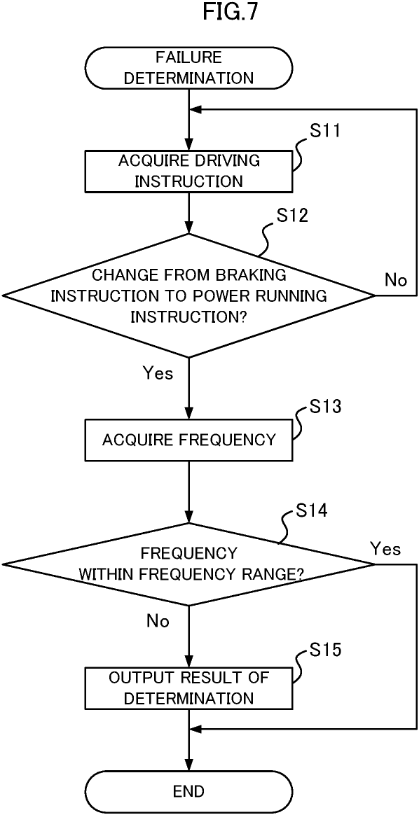

The failure determination device 1 having the above-described configuration executes a process of determining whether any failure occurs in the rotating body, which is described below with reference to FIG. 7. The failure determination device 1 executes the process illustrated in FIG. 7 in response to a change of the driving instruction.

The determiner 13 included in the failure determination device 1 acquires a driving instruction from the cab (Step S11). When the driving instruction does not change from the braking instruction or from the power running instruction, or when the driving instruction changes from the power running instruction to the braking instruction (Step S12; No), the calculator 23 repeats Step S11.

In contrast, when the driving instruction changes from the braking instruction to the power running instruction (Step S12; Yes), the determiner 13 acquires the frequency from the frequency calculator 12 (Step S13). In detail, the determiner 13 acquires, from the calculator 23, the frequency of the sensor signal, which is calculated by the calculator 23, on the basis of the pulse signal generated by the waveform generator 22, after a rise of the voltage of the pulse signal.

The determiner 13 then determines whether the frequency acquired in Step S13 is within the target frequency range (Step S14). When the frequency acquired in Step S13 is within the target frequency range (Step S14; Yes), the failure determination device 1 terminates the failure determining process.

In contrast, when the frequency acquired in Step S13 is not within the target frequency range (Step S14; No), the determiner 13 outputs a result of determination to the drive controller 31 and the brake controller 32 (Step S15). After termination of Step S15, the failure determination device 1 terminates the failure determining process.

As described above, the failure determination device 1 according to Embodiment 1 determines whether any failure occurs in the bogie including the rotating body from the frequency of the sensor signal. The failure determination device 1 determines the existence of a failure in the bogie from the frequency of the sensor signal, and is therefore not required to measure a rotational speed of another member that receives a torque from the axle, for example, a rotational speed of the armature shaft of the motor 54, and does not need a voltage detection circuit for measuring a voltage value of the sensor signal. The failure determination device 1 and the drive control apparatus 10 including the failure determination device 1 therefore have simple structures.

### Embodiment 2

The determination of the existence of a failure in the rotating body may also be based on multiple sensor signals. The description of Embodiment 2 is directed to a failure determination device 2 to determine whether any failure occurs in the bogie on the basis of multiple sensor signals.

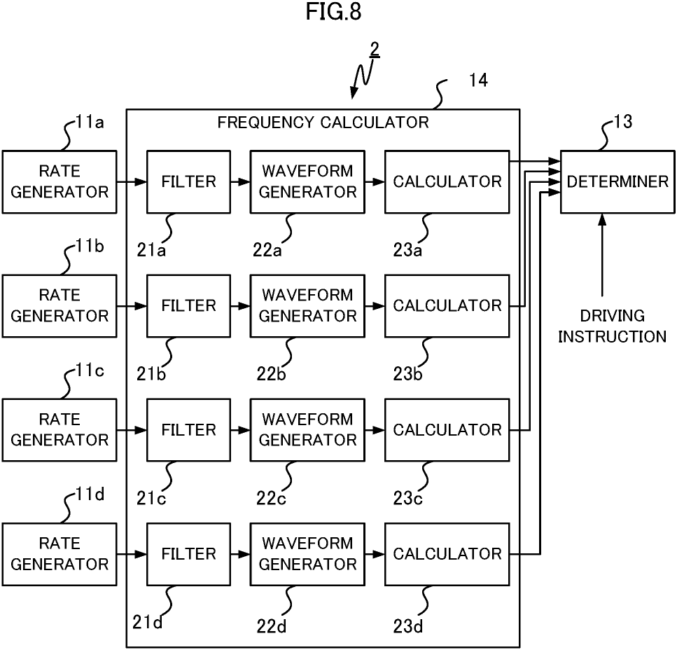

As illustrated in FIG. 8, the failure determination device 2 according to Embodiment 2 includes rate generators 11a, 11b, 11c, and 11d, a frequency calculator 14, and the determiner 13. The rate generators 11a, 11b, 11c, and 11d have the same structure and execute the same operation as the rate generator 11 included in the failure determination device 1 according to Embodiment 1. For example, the rate generators 11a, 11b, 11c, and 11d detect rotation of mutually different axles of the identical vehicle. Specifically, each vehicle included in the railway vehicle has two bogies, each of which is provided with two axles. The rate generators 11a and 11b detect rotation of mutually different axles of one of the bogies, and the rate generators 11c and 11d detect rotation of mutually different axles of the other bogie.

The frequency calculator 14 includes filters 21a, 21b, 21c, and 21d, waveform generators 22a, 22b, 22c, and 22d, and calculators 23a, 23b, 23c, and 23d.

The filters 21a, 21b, 21c, and 21d have the same structure and execute the same operation as the filter 21 of the frequency calculator 12 included in the failure determination device 1 according to Embodiment 1. The filters 21a, 21b, 21c, and 21d reduce noise superimposed on the respective sensor signals output from the rate generators 11a, 11b, 11c, and 11d.

The waveform generators 22a, 22b, 22c, and 22d have the same structure and execute the same operation as the waveform generator 22 of the frequency calculator 12 included in the failure determination device 1 according to Embodiment 1. The waveform generators 22a, 22b, 22c, and 22d generate pulse signals on the basis of the respective sensor signals after noise reduction at the filters 21a, 21b, 21c, and 21d.

The calculators 23a, 23b, 23c, and 23d have the same structure and execute the same operation as the calculator 23 of the frequency calculator 12 included in the failure determination device 1 according to Embodiment 1. The calculators 23a, 23b, 23c, and 23d count the numbers of pulses per unit time on the basis of the respective pulse signals output from the waveform generators 22a, 22b, 22c, and 22d, and calculate frequencies of the respective sensor signals. In other words, the calculators 23a, 23b, 23c, and 23d calculate frequencies of the respective sensor signals output from the rate generators 11a, 11b, 11c, and 11d.

Since the axles installed in the same bogie abrade at the similar rate, the frequencies of the sensor signals have a sufficiently small dispersion in the case of no failure in the bogie. The determiner 13 is thus configured to determine whether any failure occurs in the bogie on the basis of the dispersion of the frequencies of the sensor signals calculated by the frequency calculator 14. In detail, the determiner 13 calculates a dispersion of the frequencies of the sensor signals calculated by the frequency calculator 14 and then determines whether the dispersion is within a predetermined range. When the dispersion of the frequencies of the sensor signals is within the predetermined range, no failure is deemed to occur in the bogie. In contrast, when the dispersion of the frequencies of the sensor signals is not within the predetermined range, any failure is deemed to occur in the bogie. The predetermined range can be preliminarily defined through simulations or test runs, on the basis of possible dispersions of the frequencies of the sensor signals in the case of no failure in the bogie.

In Embodiment 2, the determiner 13 includes a subtractor and a comparator. The determiner 13 calculates a difference between the frequencies of the sensor signals from the respective rate generators 11a and 11b for detecting rotation of different axles installed in the same bogie, and then determines whether the calculated difference between the frequencies of the sensor signals from the respective rate generators 11a and 11b is equal to or higher than a difference threshold. When the difference between the frequencies of the sensor signals from the respective rate generators 11a and 11b is equal to or higher than the difference threshold, any failure is deemed to occur in the bogie including the axles of which rotational speeds are measured by the rate generators 11a and 11b. In contrast, when the difference between the frequencies of the sensor signals from the respective rate generators 11a and 11b is lower than the difference threshold, no failure is deemed to occur in the bogie including the axles of which rotational speeds are measured by the rate generators 11a and 11b.

The determiner 13 also determines whether the difference between the frequencies of the sensor signals from the respective rate generators 11c and 11d for detecting rotation of different axles installed in the same bogie is equal to or higher than the difference threshold. When the difference between the frequencies of the sensor signals from the respective rate generators 11c and 11d is equal to or higher than the difference threshold, any failure is deemed to occur in the bogie including the axles of which rotational speeds are measured by the rate generators 11c and 11d. In contrast, when the difference between the frequencies of the sensor signals from the respective rate generators 11c and 11d is lower than the difference threshold, no failure is deemed to occur in the bogie including the axles of which rotational speeds are measured by the rate generators 11c and 11d.

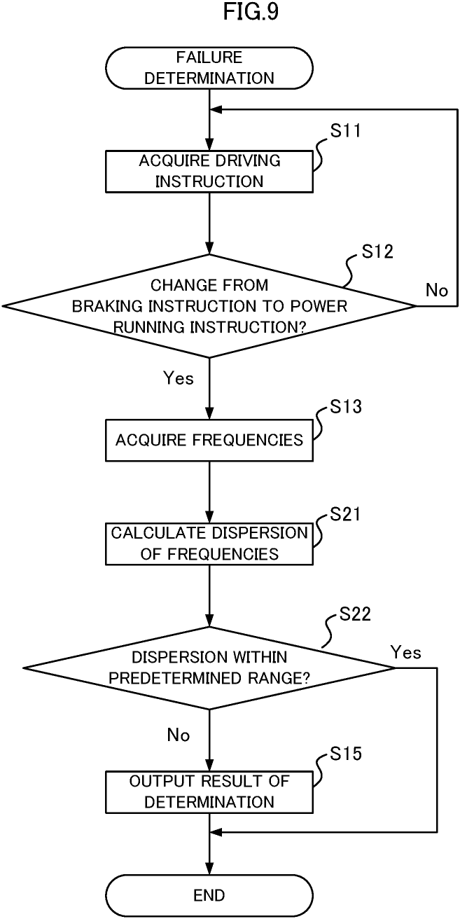

The failure determination device 2 having the above-described configuration executes a process of determining whether any failure occurs in a rotating body, which is described below with reference to FIG. 9. The failure determination device 2 executes the process illustrated in FIG. 9 in response to a change of the driving instruction.

Steps S11 to S13 are identical to those in Embodiment 1. In Step S13, the determiner 13 acquires the frequencies of the sensor signals from the respective calculators 23a, 23b, 23c, and 23d.

The determiner 13 calculates a dispersion of the frequencies of the sensor signals acquired in Step S13 (Step S21). In detail, the determiner 13 calculates a difference between the frequencies calculated by the calculators 23a and 23b and a difference between the frequencies calculated by the calculators 23c and 23d.

The determiner 13 then determines whether the dispersion of the frequencies of the sensor signals calculated in Step S21 is within the predetermined range (Step S22). In detail, the determiner 13 determines whether the difference between the frequencies calculated by the calculators 23a and 23b is lower than the difference threshold. The determiner 13 also determines whether the difference between the frequencies calculated by the calculators 23c and 23d is lower than the difference threshold.

When the dispersion of the frequencies of the sensor signals is within the predetermined range, specifically, when the difference between the frequencies calculated by the calculators 23a and 23b and the difference between the frequencies calculated by the calculators 23c and 23d are both lower than the difference threshold (Step S22; Yes), the failure determination device 2 terminates the failure determining process.

In contrast, when the dispersion of the frequencies of the sensor signals is not within the predetermined range, specifically, when either the difference between the frequencies calculated by the calculators 23a and 23b or the difference between the frequencies calculated by the calculators 23c and 23d is equal to or higher than the difference threshold (Step S22; No), the determiner 13 outputs a result of determination to the drive controller 31 and the brake controller 32 (Step S15). After termination of Step S15, the failure determination device 2 terminates the failure determining process.

As described above, the failure determination device 2 according to Embodiment 2 determines whether any failure occurs in the bogie including the rotating bodies from the frequencies of multiple sensor signals. Since the determination of the existence of a failure in the bogie is conducted from the dispersion of the frequencies of the sensor signals, the failure determination device 2 is able to detect a failure, such as abrasion in only some of the axles in the same bogie, for example.

The above-described embodiments are mere examples and may be arbitrarily combined with each other. The above-described hardware configurations and flowcharts are mere examples and may be arbitrarily varied and modified.

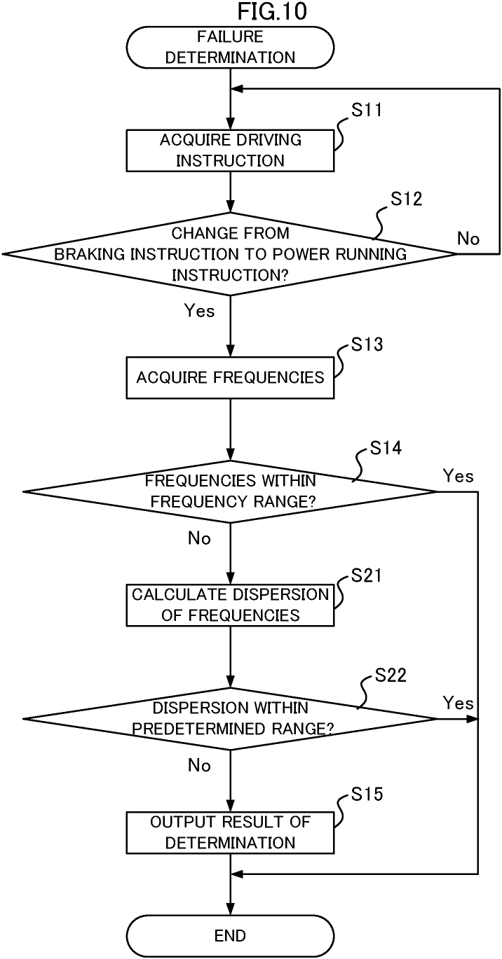

For example, the failure determination device 2 may determine whether the dispersion of the frequencies of the sensor signals is within the predetermined range, when each of the frequencies of the sensor signals is not within the target frequency range. In detail, as illustrated in FIG. 10, the determiner 13 determines whether each of the frequencies of the sensor signals calculated by the calculators 23a, 23b, 23c, and 23d is within the target frequency range (Step S14). When each of the frequencies of the sensor signals calculated by the calculators 23a, 23b, 23c, and 23d is within the target frequency range (Step S14; Yes), the failure determination device 2 terminates the failure determining process.

In contrast, when at least any of the frequencies of the sensor signals calculated by the calculators 23a, 23b, 23c, and 23d is not within the target frequency range (Step S14; No), the determiner 13 calculates a dispersion of the frequencies of the sensor signals acquired in Step S13 (Step S21). The following steps are identical to those in Embodiment 2. The failure determination device 2 executing the process illustrated in FIG. 10 determines whether each of the frequencies of the sensor signals is within the target frequency range and then determines the existence of a failure in the bogie on the basis of the dispersion of the frequencies of the sensor signals, thereby achieving the determination of the existence of a failure in the rotating body with high accuracy.

Although the failure determination device 2 includes four rate generators 11a, 11b, 11c, and 11d, the failure determination device 2 may also include any number of rate generators. For example, the failure determination device 2 may include a rate generator 11a to output a sensor signal of which the frequency varies depending on the rotational speed of one axle of one of the two bogies provided to the same vehicle, and a rate generator 11b to output a sensor signal of which the frequency varies depending on the rotational speed of one axle of the other of the two bogies provided to the same vehicle.

The determiner 13 may determine whether the axle starts rotation on the basis of a signal other than the driving instruction. For example, the determiner 13 may deem the axle to start rotation when a door open/close signal changes from a level indicating the opening of doors to a level indicating the closing of the doors.

The dispersion of the frequencies of the sensor signals is not necessarily the difference between the frequencies of the sensor signals. For example, the determiner 13 included in the failure determination device 2 may determine whether the difference between the frequency of each sensor signal and the average of the frequencies of the other sensor signals is equal to or higher than a difference threshold. For example, the determiner 13 determines whether the difference between the frequency of the sensor signal from the rate generator 11a and the average of the frequencies of the sensor signals from the rate generators 11b, 11c, and 11d is equal to or higher than the difference threshold. In this case, when the difference between the frequency of the sensor signal from the rate generator 11a and the average of the frequencies of the sensor signals from the rate generators 11b, 11c, and 11d is equal to or higher than the difference threshold, any failure is deemed to occur in the axle of which a rotational speed is measured by the rate generator 11a or the bearing for supporting the axle rotatably.

For another example, the determiner 13 may determine whether the difference between the maximum and minimum values of the frequencies of the sensor signals is equal to or higher than a difference threshold. When the difference between the maximum and minimum values of the frequencies of the sensor signals is equal to or higher than the difference threshold, any failure is deemed to occur in the bogie.

For another example, the determiner 13 may determine the existence of a sign of a failure on the basis of another frequency range defined separately from the target frequency range. For example, the determiner 13 determines the existence of a sign of a failure using a first frequency range, which is the target frequency range mentioned in the above-described embodiments, and a second frequency range different from the first frequency range. In detail, the determiner 13 may determine whether the frequency calculated by the frequency calculator 12 is within the first frequency range, and, when the frequency calculated by the frequency calculator 12 is not within the first frequency range, determine whether the frequency calculated by the frequency calculator 12 is within the second frequency range. The second frequency range encompasses the first frequency range. For example, the second frequency range is defined by increasing the upper limit of the first frequency range by 30% and decreasing the lower limit by 30%.

When the frequency calculated by the frequency calculator 12 is within the first frequency range, neither a failure nor a sign of a failure is deemed to exist in the bogie. When the frequency calculated by the frequency calculator 12 is not within the first frequency range but is within the second frequency range, any sign of a failure is deemed to exist in the bogie despite of no failure in the bogie. When the frequency calculated by the frequency calculator 12 is not within both of the first frequency range and the second frequency range, any failure is deemed to occur in the bogie. These operations at the determiner 13 can achieve determination of the existence of a sign of a failure in advance of occurrence of a failure. The failure determination device 1 including the determiner 13 executing the above-described process preferably transmits a result of determination regarding the existence of a sign of a failure and a result of determination regarding the existence of a failure to the drive controller 31 and the brake controller 32.

For another example, the determiner 13 may repeat the determining process every time when a predetermined determination condition is satisfied, and determine the existence of a sign of a failure on the basis of multiple results of determination. In detail, the determiner 13 determines the existence of a sign of a failure using the first frequency range, which is the target frequency range mentioned in the above-described embodiments, and a third frequency range different from the first frequency range. In detail, the determiner 13 determines whether the frequency calculated by the frequency calculator 12 is within the first frequency range at the start of the first run every day, and, when the frequency calculated by the frequency calculator 12 is within the first frequency range, determines whether the frequency calculated by the frequency calculator 12 is within the third frequency range. The determiner 13 causes results of these determinations to be stored into a memory, which is not illustrated. The determiner 13 then determines whether all the results of the recent determinations stored in the memory indicate that the frequencies calculated by the frequency calculator 12 are not within the third frequency range. The third frequency range is encompassed in the first frequency range. For example, the third frequency range is defined by decreasing the upper limit of the first frequency range by 30% and increasing the lower limit by 30%.

When all the results of the recent determinations stored in the memory, for example, all the results of the determinations for the latest week indicate that the frequencies calculated by the frequency calculator 12 are not within the third frequency range, that is, the frequencies of the sensor signals have been within the first frequency range designed for determination of the existence of a failure but close to the upper or lower limit of the first frequency range for the latest period, then any sign of a failure is deemed to exist. These operations at the determiner 13 can achieve determination of the existence of a sign of a failure in advance of occurrence of a failure. The failure determination device 1 including the determiner 13 executing the above-described process preferably transmits the results of determinations regarding the existence of a sign of a failure and the results of determinations regarding the existence of a failure to the drive controller 31 and the brake controller 32.

The determination condition may be any condition other than the above-mentioned examples. For example, the determiner 13 may execute the determination process every time when the railway vehicle departs from a predetermined terminal station. For another example, the determiner 13 may execute the determination process every time when the railway vehicle departs from a station.

The failure determination devices 1 and 2 may always transmit a result of determination at the determiner 13 to the drive controller 31 and the brake controller 32, regardless of the content of the result.

The drive control apparatus 10 may have any configuration other than the above-described examples, provided that the drive control apparatus 10 can control a driving apparatus for providing power to a rotating body. For example, the brake controller 32 included in the drive control apparatus 10 may cause only mechanical braking force to be generated by the mechanical brake device 55. When the failure determination device 1 determines that any failure occurs, the brake controller 32 may control the mechanical brake device 55 to activate a regular brake or activate an emergency brake. For another example, the brake controller 32 may cause a braking resistor to consume three-phase AC power generated by the motor 54, which serves as an electric generator during braking of the railway vehicle, and thereby generate electric braking force.

The driving apparatus 50 may have any configuration other than the above-described examples, provided that the driving apparatus 50 can provide power to a rotating body. For example, the driving apparatus 50 may be installed in any moving body, such as automobile, aircraft, or marine vessel, and generate a thrust of the moving body.

The driving apparatus 50 may also be installed in an electric railway vehicle of an AC feeding system as well as an electric railway vehicle of a DC feeding system. Alternatively, the driving apparatus 50 may be installed in a diesel vehicle for obtaining power from an internal combustion engine.

The rate generators 11, 11a, 11b, 11c, and 11d detect rotation of the axles in the above-described examples, but may also detect rotation of objects other than the axles. The rotating body, on which the failure determination devices 1 and 2 determine the existence of a failure, may be any rotating body including a shaft rotatable by received power and a support mechanism supporting the shaft rotatably. For example, the rate generator 11 included in the failure determination device 1 may output a sensor signal of which the frequency varies depending on the rotational speed of the armature shaft of the motor 54. In detail, the gear of the rate generator 11 is attached to the armature shaft of the motor 54. In this case, the failure determination device 1 determines the existence of a failure in the motor 54, from the frequency of the sensor signal that varies depending on the rotational speed of the armature shaft of the motor 54.

Also, the failure determination device 2 may determine the existence of a failure in multiple motors 54 provided to mutually different vehicles, from the dispersion of frequencies of the sensor signals, which are output from the rate generators 11a, 11b, 11c, and 11d and of which frequencies vary depending on the respective rotational speeds of the armature shafts of the motors 54.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

Reference Signs List

| | |
|---|---|
| 1, 2 | Failure determination device |
| 10 | Drive control apparatus |
| 11, 11a, 11b, 11c, 11d | Rate generator |
| 12, 14 | Frequency calculator |
| 13 | Determiner |
| 21, 12a, 21b, 21c, 21d | Filter |
| 22, 22a, 22b, 22c, 22d | Waveform generator |
| 23, 23a, 23b, 23c, 23d | Calculator |
| 31 | Drive controller |
| 32 | Brake controller |
| 50 | Driving apparatus |
| 51 | Overhead wire |
| 52 | Current collector |
| 53 | Electric power converter |
| 54 | Motor |

1. A failure determination device to determine whether any failure occurs in a rotating body including a shaft rotatable by received power and a support mechanism for supporting the shaft rotatably, the failure determination device comprising:
a rate generator to output a sensor signal of which a frequency varies depending on a rotational speed of the shaft;
frequency calculating circuitry to calculate the frequency of the sensor signal output from the rate generator; and
determining circuitry to determine whether any failure occurs in the rotating body from the frequency calculated by the frequency calculating circuitry.

2. The failure determination device according to claim 1, wherein the detemining circuitry determines whether any failure occurs in the rotating body from the frequency calculated by the frequency calculating circuitry during acceleration of the rotational speed of the shaft after start of rotation of the shaft.

3. The failure determination device according to claim 2, wherein the frequency calculating circuitry
generates a pulse signal on basis of whether a voltage of the sensor signal is equal to or higher than a threshold voltage, and
starts calculating the frequency of the sensor signal on basis of the pulse signal in response to a rise of the pulse signal after start of rotation of the shaft.

4. The failure determination device according to claim 3, wherein the determining circuitry determines whether any failure occurs in the rotating body from the frequency calculated by the frequency calculating circuitry, the frequency being calculated immediately after a first rise of the pulse signal since start of rotation of the shaft.

5. The failure determination device according to claim 1, wherein the determining circuitry determines whether the frequency calculated by the frequency calculating circuitry is within a target frequency range.

6-14. (canceled)

15. The failure determination device according to claim 2, wherein the determining circuitry determines whether the frequency calculated by the frequency calculating circuitry is within a target frequency range.

16. The failure determination device according to claim 3, wherein the determining circuitry determines whether the frequency calculated by the frequency calculating circuitry is within a target frequency range.

17. The failure determination device according to claim 4, wherein the determining circuitry determines whether the frequency calculated by the frequency calculating circuitry is within a target frequency range.

18. The failure determination device according to claim 1, wherein
the rate generator comprises a plurality of rate generators,
the plurality of rate generators detects rotation of shafts included in the rotating body and outputs sensor signals,
the frequency calculating circuitry acquires the sensor signals from the plurality of respective rate generators, and calculates frequencies of the sensor signals acquired from the plurality of respective rate generators, and
the determining circuitry determines whether any failure occurs in the rotating body from the respective frequencies of the sensor signals calculated by the frequency calculating circuitry.

19. The failure determination device according to claim 1, wherein
the rate generator comprises a plurality of rate generators,
the plurality of rate generators detects rotation of shafts included in respective rotating bodies and outputs sensor signals,
the frequency calculating circuitry acquires the sensor signals from the plurality of respective rate generators, and calculates frequencies of the sensor signals acquired from the plurality of respective rate generators, and
the determining circuitry determines whether any failure occurs in the rotating bodies from the respective frequencies of the sensor signals calculated by the frequency calculating circuitry.

20. The failure determination device according to claim 2, wherein
the rate generator comprises a plurality of rate generators,
the plurality of rate generators detects rotation of shafts included in respective rotating bodies and outputs sensor signals,
the frequency calculating circuitry acquires the sensor signals from the plurality of respective rate generators, and calculates frequencies of the sensor signals acquired from the plurality of respective rate generators, and
the determining circuitry determines whether any failure occurs in the rotating bodies from the respective frequencies of the sensor signals calculated by the frequency calculating circuitry.

21. The failure determination device according to claim 5, wherein
the rate generator comprises a plurality of rate generators,
the plurality of rate generators detects rotation of shafts included in respective rotating bodies and outputs sensor signals,
the frequency calculating circuitry acquires the sensor signals from the plurality of respective rate generators, and calculates frequencies of the sensor signals acquired from the plurality of respective rate generators, and
the determining circuitry determines whether any failure occurs in the rotating bodies from the respective frequencies of the sensor signals calculated by the frequency calculating circuitry.

22. The failure determination device according to claim 1, wherein the determining circuitry notifies a drive control apparatus of whether any failure occurs in the rotating body, the drive control apparatus being configured to control a driving apparatus for providing power to the shaft.

23. The failure determination device according to claim 1, wherein the rate generator detects rotation of the shaft and outputs the sensor signal, the shaft being an axle configured to rotate by power received from a driving apparatus for generating a thrust of a vehicle.

24. The failure determination device according to claim 1, wherein the rate generator detects rotation of the shaft and outputs the sensor signal, the shaft being an armature shaft of a motor included in a driving apparatus installed in a vehicle and configured for generating a thrust of the vehicle.

25. The failure determination device according to claim 23, wherein the determining circuitry
acquires a driving instruction for the vehicle, and
determines, when the driving instruction changes from a braking instruction to a power running instruction, that the shaft starts rotation, the braking instruction being an instruction for instructing the vehicle to decelerate, the power running instruction being an instruction for instructing the vehicle to accelerate.

26. The failure determination device according to claim 24, wherein the determining circuitry
acquires a driving instruction for the vehicle, and
determines, when the driving instruction changes from a braking instruction to a power running instruction, that the shaft starts rotation, the braking instruction being an instruction for instructing the vehicle to decelerate, the power running instruction being an instruction for instructing the vehicle to accelerate.

27. A drive control apparatus comprising:
the failure determination device according to claim 23; and
drive controlling circuitry to acquire a driving instruction for the vehicle and, when the driving instruction is a power running instruction for instructing the vehicle to accelerate, control the driving apparatus in accordance with the power running instruction, wherein
when the determining circuitry included in the failure determination device determines that any failure occurs in the rotating body, the drive controlling circuitry stops the driving apparatus regardless of the driving instruction.

28. The drive control apparatus according to claim 27, further comprising:
brake controlling circuitry to acquire the driving instruction and, when the driving instruction is a braking instruction for instructing the vehicle to decelerate, control a brake device in accordance with the braking instruction, the brake device being configured to generate braking force of the vehicle, wherein
when the determining circuitry included in the failure determination device determines that any failure occurs in the rotating body, the brake controlling circuitry controls the brake device to generate braking force of the vehicle regardless of the driving instruction.

29. A failure determining method for determining whether any failure occurs in a rotating body including a shaft rotatable by received power and a support mechanism for supporting the shaft rotatably, the failure determining method comprising:
calculating a frequency of a sensor signal output from a rate generator, the rate generator being configured to output the sensor signal of which a frequency varies depending on a rotational speed of the shaft; and
determining whether any failure occurs in the rotating body from the calculated frequency of the sensor signal.
